(19) United States
(12) Patent Application Publication
(10) Pub. No.: US 2007/0182190 A1
(43) Pub. Date: Aug. 9, 2007

(54) Vehicle loading space with a loading space covering

(76) Inventors: Herbert Walter, Ebersbach (DE); Wolfgang Stark, Denkendorf (DE); Werner P. Schlecht, Vaihingen/Enz Aurich (DE)

Correspondence Address: FLYNN THIEL BOUTELL & TANIS, P.C., 2026 RAMBLING ROAD, KALAMAZOO, MI, 49008-1631, US

(21) Appl. No.: 11/701,242

(22) Filed: Feb. 1, 2007

(30) Foreign Application Priority Data
Feb. 1, 2006 (DE) 10 2006 005673.6

(51) Int. Cl. B60N 3/12

(52) U.S. Cl. 296/37.16

(57) ABSTRACT

Motor vehicle loading space with a loading space covering. A motor vehicle loading space with a loading space covering which has a flexible sheetlike structure which is mounted in a manner such that it can be wound up and unwound on a winding shaft fixed on the vehicle and which is guided by means of a dimensionally stable extension profile in profiled guide structures, which are arranged on opposite sides of the loading space fixed on the vehicle, is known. According to the invention, a respective screening profile is provided on both sides of the loading space and respectively covers a side edge of the sheetlike structure above an upper side of the sheetlike structure in the approximately horizontally extended functional position thereof. Use for passenger vehicles.

### FIELD OF THE INVENTION

The invention relates to a motor vehicle loading space with a loading space covering which has a flexible sheetlike structure which is mounted in a manner such that it can be wound up and unwound on a winding shaft fixed on the vehicle and which is guided by means of a dimensionally stable extension profile, which is arranged on a front end region of the sheetlike structure, in profiled guide structures, which are arranged on opposite sides of the loading space fixed on the vehicle.

### BACKGROUND OF THE INVENTION

A motor vehicle loading space of this type is generally known for passenger vehicles, such as estate vehicles, vans or SUVs. Loading spaces of this type usually have a loading space covering, which comprises a flexible sheetlike structure held in a manner such that it can be wound up and unwound on a winding shaft. The sheetlike structure is designed as an opaque textile structure. The winding shaft is mounted rotatably in a cassette housing, which is oriented in the transverse direction of the vehicle approximately level with a window breast and is arranged directly behind a backrest arrangement of a rear seat bench. On its front end edge in the extension direction, the textile structure has a dimensionally stable extension profile, which is usually provided with a dimensionally stable contour part. The extension profile extends over the entire width of the textile structure and protrudes with its opposite ends over the textile structure on both sides. The extension profile is held by means of the ends in profiled guide structures on the vehicle in a manner such that it can be displaced in the longitudinal direction of the vehicle. The profiled guide structures are arranged on opposite side walls of the loading space. During an extension or retraction movement of the textile structure, the extension profile is guided with its opposite ends in the profiled guide structures. In the rear end region of the loading space, the profiled guide structures are assigned latching troughs in order to make it possible to block the extension profile in the extended position of the textile structure. In the extended position of the textile structure, there is a narrow gap between the side edges of the textile structure and the profiled guide structures or the side breasts, through which gap, under some circumstances, the bottom of the loading space can be seen from outside the motor vehicle.

It is the object of the invention to provide a motor vehicle loading space of the type mentioned at the beginning, which permits improved protection against goods located on the loading space floor being seen.

This object is achieved in that a respective screening profile is provided on both sides of the loading space and respectively covers a side edge of the sheetlike structure above an upper side of the sheetlike structure in the approximately horizontally extended functional position thereof. As a result, secure protection against the loading space located below the loading space covering being seen is obtained even in the side edge region of the sheetlike structure in the extended functional position. Since the side edges of the sheetlike structure are covered by the respective screening profile on the opposite sides of the loading space, neither the profiled guide structures on the side walls nor the guide means assigned to the sheetlike structure, such as the extension profile or similar, are visible, but rather are concealed. This gives rise, when the sheetlike structure is extended, to a particularly uniform and attractive, visual impression of the loading space. The screening profile can be matched in shape and design to the interior soft trim of the motor vehicle and/or to the design and choice of material of the sheetlike structure. The winding shaft is preferably mounted rotatably in a cassette housing, which is arranged fixed on the loading space. A further winding shaft for a separating net for the approximately vertical separation of the loading space from the passenger compartment may also be arranged in the cassette housing.

In a refinement of the invention, tensioning means which tension the sheetlike structure transversely with respect to its winding direction are assigned to the side edges of the sheetlike structure in the region of a lower side. This prevents the sheetlike structure from sagging in the middle in the extended functional position. A flat visual impression thus arises for the extended functional position without the sheetlike structure requiring transverse stiffening means repeated over the extension length of the sheetlike structure.

In a further refinement of the invention, the tensioning means each have a profiled strip which is fitted to the lower side of the sheetlike structure in the region of the respective side edge and is in each case provided with a supporting section, which is supported in an interlocking manner transversely with respect to the winding direction toward a center of the loading space on a web portion of the respective profiled guide structure. This is a particularly simple mechanical solution which is functionally reliable.

In a further refinement of the invention, each profiled strip has a Z-like cross section. In this case, the two Z limbs of the profiled strip are preferably oriented approximately parallel to each other. The one Z limb is fitted in a planar manner to the lower side of the respective side edge of the sheetlike structure. The other Z limb preferably runs at a parallel distance to the lower side of the sheetlike structure. The two Z limbs are connected to each other by a transverse section which is preferably oriented at an obtuse angle to both Z limbs. As a result, the two Z limbs do not overlap each other in the transverse direction, as in the case of a conventional Z, but rather are spaced apart from each other in the transverse direction of the profiled strip by means of the transverse section. The planar fitting of the one Z limb of each profiled strip on the lower side of the respective side edge of the sheetlike structure means that this side edge remains flat, and it is therefore possible to select the distance of the screening profile from the respective side edge region to be very small. In particular, the screening profile can be realized in a horizontal and flat manner parallel to the side edge region.

In a further refinement of the invention, the screening profile protrudes toward the center of the loading space into the loading space. The respective screening profile on each side of the loading space is preferably oriented parallel to the extended sheetlike structure.

In a further refinement of the invention, the screening profile is an integral part of the profiled guide structure, which is connected integrally in particular to the side breast. This makes it possible to produce the profiled guide structure cost-effectively as a plastic part and to integrate a plurality of functions in the profiled guide structure.

The flexible sheetlike structure has a width in the transverse direction of the vehicle that is greater than a clear width of the loading space—likewise as seen in the transverse direction of the vehicle. The clear width of the loading space is to be understood as meaning the distance of the opposite side walls from each other. By means of this refinement, the flexible sheetlike structure inevitably dips under the screening profiles during an extension operation such that the side edges of the sheetlike structure are covered by the screening profiles.

Further advantages and features of the invention emerge from the claims and from the description below of preferred exemplary embodiments of the invention, which are illustrated with reference to the drawings.

### BRIEF DESCRIPTION OF THE DRAWINGS

FIG. 1 shows, in a perspective illustration, a cutout of a passenger vehicle in the region of a rear loading space according to one exemplary embodiment of the invention,

FIG. 2 shows a cross section through a side guide of a sheetlike structure of the loading space covering according to FIG. 1, and

FIG. 3 shows a further loading space covering for a further embodiment of a loading space according to the invention.

### DETAILED DESCRIPTION

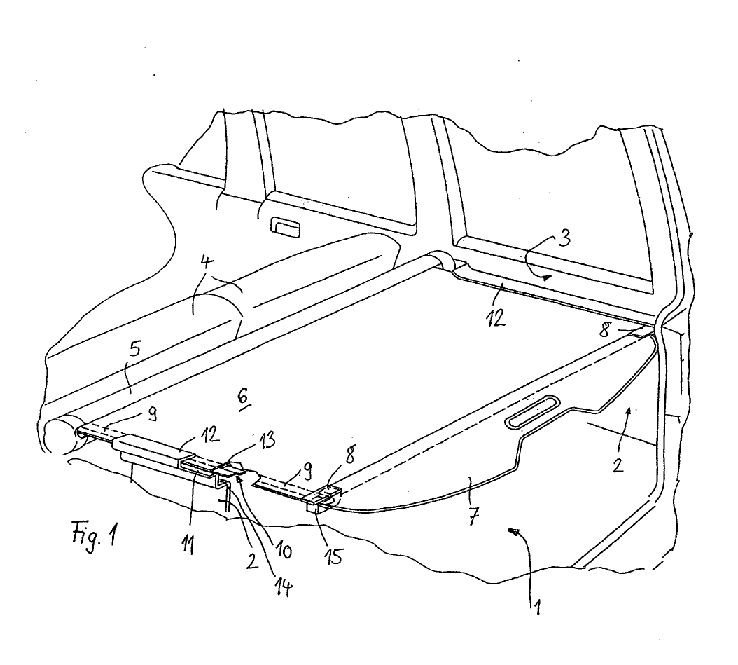

A passenger vehicle in the form of an estate vehicle, a van or an SUV has, according to FIG. 1, a vehicle interior which is provided with a rear with a loading space 1. The loading space 1 has a loading space floor (not denoted specifically). To the front in the longitudinal direction of the vehicle, the loading space 1 is delimited by a backrest arrangement 4 of a single or multi-part rear seat bench. The rear seat bench is part of a passenger compartment of the motor vehicle. The loading space 1 is delimited from the opposite sides of the vehicle by means of a respective side wall 2. The side wall 2 is preferably formed by soft trim parts which are connected fixedly to a body shell. The soft trim parts are realized to be dimensionally stable and cover a vehicle body shell on the inside in a basically known manner.

The side walls 2 merge below a vehicle window-base edge, which is at least approximately formed by lower edges of side window frames of the vehicle, into a respective side breast 3, which forms the transition of the loading space side walls 2 to the vehicle window-base edge.

A cassette housing 5 is provided level with the side breasts 3, said cassette housing being arranged directly behind the backrest arrangement 4 of the rear seat bench and extending in the transverse direction of the vehicle. The cassette housing 5 is fixed on the loading space. For this purpose, corresponding mounts, to which the cassette housing 5 is releasably connected, are provided in the side breasts 3 or in the region of the rear side of the backrest arrangement 4. The cassette housing 5 is designed as a hollow body in which a winding shaft is rotatably mounted. The winding shaft extends in the longitudinal direction of the cassette housing 5 and therefore likewise in the transverse direction of the vehicle over the length of the cassette housing 5. A flexible sheetlike structure 6 in the form of an opaque textile covering is held in a manner such that it can be wound up and unwound on the winding shaft. In the winding-up direction, the winding shaft is subjected to torque by means of a winding spring arrangement, and therefore the sheetlike structure 6 is automatically rolled up onto the winding shaft in the winding-up direction by the spring force of the winding spring arrangement.

On its front end region in the unwinding direction, the sheetlike structure 6 has a dimensionally stable extension profile 7, in the present case in the form of a dimensionally stable contour part, which extends over the entire width of the flexible sheetlike structure 6. The dimensionally stable extension profile 7 is provided on its opposite end regions below the plane of the sheetlike structure 6 with a respective sliding block 15, which is guided over an extension path of the extension profile 7 and therefore of the flexible sheetlike structure 6 in a respective corresponding profile guide structure 14 in the region of the side breast 3. The profiled guide structure 14 on each side of the vehicle upwardly adjoins the respective side wall 2 as a groove which is open toward the center of the loading space or as a correspondingly open hollow profile. In the exemplary embodiment illustrated, the profiled guide structure 14 is integrally formed on the plastic shell forming the side wall 2. The two sliding blocks 15 on opposite end sides of the extension profile 7 are therefore guided in the profiled guide structures 14 in a manner such that they can be displaced in the longitudinal direction of the vehicle over the entire extension path of the extension profile 7 from its wound-up inoperative position into the rear end position.

FIG. 1 illustrates the extended end position of the extension profile 7 and therefore of the sheetlike structure 6. In this end position, the sliding blocks 15 are mechanically blocked by securing means (not illustrated specifically) in order to avoid unintentional rolling up of the sheetlike structure 6 during the driving mode. The securing means can be formed by corresponding latching positions in the profiled guide structures 14 or else by separate catch elements or locking elements, which block the sliding blocks 15 and therefore the extension profile 7 in an interlocking manner in the extended end position. The catch elements or locking elements are transferred into their release position as soon as the sheetlike structure 6 is to be released from the end position.

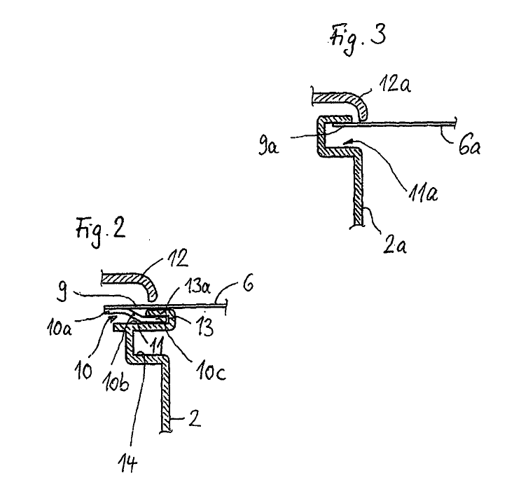

The sheetlike structure 6 is extended with its opposite side edge regions 9 in the transverse direction of the vehicle beyond the sliding blocks 15, as can be seen with reference to FIGS. 1 and 2. The side edge regions 9 are guided within guide slots 11 of the side breasts 3. An upper side of the side edge regions 9 of the flexible sheetlike structure 6 is covered by a respective screening profile 12, which is extended toward the center of the loading space.

In order to tension the side edge regions 9 of the sheetlike structure 6, which regions are arranged above the sliding blocks 15, firstly a respective supporting tab 8, which is realized to be dimensionally stable and grasps the respective side edge region 9, is provided level with the extension profile 7. Secondly, profiled strips 10, which have sufficient inherent rigidity in the transverse direction of the vehicle, are fitted in the region of the lower side of the side edge regions 9. In the longitudinal direction of the sheetlike structure 6, the profiled strips 10 are designed in a flexible manner such that they can be wound up together with the sheetlike structure 6 onto the winding shaft. According to FIG. 2, each profiled strip 10 has a first strip section 10a which is fitted, in particular bonded or sewn, in a planar manner to the lower side of the side edge region 9 of the flexible sheetlike structure 6. Each profiled strip 10 extends at least over the length of the flexible sheetlike structure 6, which length, in the extended end position of the flexible sheetlike structure 6, corresponds to the distance of the cassette housing 5 from the extension profile 7. The profiled strip 10 is of approximately Z-like design in cross section, as can be seen with reference to FIG. 2. A strip section 10b adjoining the strip section 10a extends obliquely downward and toward the center of the loading space. This central strip section 10b is adjoined by a further strip section 10c, which serves as a supporting section for the profiled strip 10. The supporting section 10c is oriented approximately parallel to the strip section 10a and extends from the central strip section 10b in the opposite direction to the strip section 10a.

The guide slot 11 for receiving the side edge region 9 of the flexible sheetlike structure 6 and for guiding the respective supporting tab 8 of the extension profile 7 is provided below the sheetlike structure 6 with a web section 13, which is oriented in the vertical direction of the vehicle and forms an interlocking support against a movement of the profiled strip 10 towards the center of the loading space. The web section 13 is additionally provided with a guide section 13a which overlaps the supporting section 10c of the profiled strip 10 from above, and therefore extends between the profiled strip 10 and the lower side of the sheetlike structure 6. The web section 13 and the guide section 13a together with a bottom of the guide slot 11 form a groove or slot-like guide for the supporting section 10c of the profiled strip 10. Since each profiled strip 10 which is arranged on the lower side of the respective side edge region 9 of the sheetlike structure 6 has sufficient inherent rigidity, and since each profiled strip 10 can be supported toward the center of the vehicle on the web section 13 of the guide slot 11, the sheetlike structure 6 is guided over the length of its extension path into the side edge regions 9 in a manner such that it is tensioned in the transverse direction of the vehicle and therefore in the transverse direction of the sheetlike structure 6. In addition, the side edge regions 9 of the flexible sheetlike structure 6 are covered by the screening profiles 12 such that, when the sheetlike structure 6 is extended as per FIG. 1, a visually attractive, flat loading space covering arises for the loading space 1, said loading space covering covering the loading space 1 approximately horizontally and therefore approximately parallel to a loading space floor level with the side breasts 3.

The profiled guide structure 14 in the region of each side breast is arranged below the guide slot 11, as can be seen with reference to FIGS. 1 and 2. As can be seen with reference to FIG. 2, the profiled guide structure 14 and the guide slot 10, including the web section 13 and guide section 13a, are an integral part of the side wall 2. As can be seen with reference to FIG. 1, the screening profile 12 can likewise be an integral part of the plastic part forming the side wall 2. However, it is also possible to produce side wall 2 and side breast 3 from separate parts. For this situation, the screening profile 12 may be an integral part of the side breast 3. In the case of the exemplary embodiment according to FIG. 1, the side wall 2 and the side breast 3 are designed overall as an integral soft trim part.

The exemplary embodiment according to FIG. 3 corresponds to the exemplary embodiment described previously with reference to FIGS. 1 and 2 except for the differences described below. To avoid repetitions, reference is therefore made in this regard to the disclosure for FIGS. 1 and 2. The essential difference in the case of the embodiment according to FIG. 3 is that the flexible sheetlike structure 9a is not tensioned by corresponding profiled strips on its opposite side edge regions 9a but rather is merely supported in the region of its extension profile as far as the side edge regions 9a. In the case of the embodiment according to FIG. 3, this support takes place in the manner provided by the supporting tabs 8 of the extension profile 7 according to FIG. 1. In this case, a corresponding supporting profile, which serves as the extension profile, can be continued in a simple manner in the transverse direction of the vehicle into the side edge regions 9a of the sheetlike structure 6a and can be supported in a sliding manner in profiled guide structures 11a of the side breast or of the side wall 2a. Both the profiled guide structure 11a and the side edge region 9a are covered on each side of the loading space 1 by a screening profile 12a, which extends above the upper side of the sheetlike structure 6a toward the center of the vehicle. This results, in the same manner as in the case of the embodiment according to FIG. 2, in a visually attractive, visually closed transition between the side breast 3 or the side wall 2a toward the center of the loading space when the sheetlike structure 6a is in its extended end position. This is because the surface of the screening profile 12a then merges into the upper side of the sheetlike structure 6a without it being possible to see a gap between the side edge regions 9a of the sheetlike structure 6a and the side breast or the side wall. The screening profile 12a is curved, as seen in cross section, toward its side edge facing the sheetlike structure 6a, as can be gathered from FIG. 3. The same applies to the screening profile 12 according to FIG. 2.

1. Motor vehicle loading space with a loading space covering which has a flexible sheetlike structure which is mounted in a manner such that it can be wound up and unwound on a winding shaft fixed on the vehicle and which is guided by means of a dimensionally stable extension profile, which is arranged on a front end region of the sheetlike structure, in profiled guide structures, which are arranged on opposite sides of the loading space fixed on the vehicle, characterized in that a respective screening profile (12, 12a) is provided on both sides of the loading space and respectively covers a side edge (9, 9a) of the sheetlike structure (6, 6a) above an upper side of the sheetlike structure (6, 6a) in the approximately horizontally extended functional position thereof.

2. Motor vehicle loading space according to claim 1, characterized in that tensioning means (10, 13) which tension the sheetlike structure (6) transversely with respect to its winding direction are assigned to the side edges (9) in the region of a lower side.

3. Motor vehicle loading space according to claim 2, characterized in that the tensioning means each have a profiled strip (10) which is fitted to the lower side of the sheetlike structure (6) in the region of the respective side edge (9) and is in each case provided with a supporting section (10c), which is supported in an interlocking manner transversely with respect to the winding direction toward a center of the loading space on a web portion (13) of the respective profiled guide structure (11).

4. Motor vehicle loading space according to claim 3, characterized in that each profiled strip (10) has a Z-like cross section.

5. Motor vehicle loading space according to claim 1, characterized in that the screening profile (12, 12a) protrudes toward the center of the loading space into the loading space.

6. Motor vehicle loading space according to claim 5, characterized in that the screening profile (12, 12a) is an integral part of the profiled guide structure (11, 11a), which is connected integrally in particular to the side breast.

7. Motor vehicle loading space according to claim 1, characterized in that the flexible sheetlike structure has a width in the transverse direction of the vehicle that is greater than a clear width of the loading space—likewise as seen in the transverse direction of the vehicle.
